(19) United States
(12) Patent Application Publication
(10) Pub. No.: US 2026/0040352 A1
(43) Pub. Date: Feb. 5, 2026

(54) METHOD AND DEVICE FOR RESOURCE SELECTION

(71) Applicant: Beijing Xiaomi Mobile Software Co., Ltd., Beijing (CN)

(72) Inventors: Wensu ZHAO, Beijing (CN); Qun ZHAO, Beijing (CN)

(73) Assignee: Beijing Xiaomi Mobile Software Co., Ltd., Beijing (CN)

(21) Appl. No.: 18/998,059

(22) PCT Filed: Aug. 2, 2022
(86) PCT No.: PCT/CN2022/109813

§ 371 Date: Jan. 23, 2025

(51) Int. Cl. H04W 74/0808

(52) U.S. Cl. CPC H04W 74/0808

(57) ABSTRACT

A method for resource selection is provided. The method for resource selection includes: receiving channel occupancy time (COT) sharing information from a second UE; determining, according to at least one of the COT sharing information or a preset threshold, whether a first UE can share a COT indicated by the COT sharing information; and selecting, in a case where the first UE can share the COT, a transmission resource of the first UE from a time window that the first UE can use within the COT.

### CROSS-REFERENCE TO RELATED APPLICATIONS

The present application is a U.S. National Stage of International Application No. PCT/CN2022/109813, filed on Aug. 2, 2022, the contents of all of which are incorporated herein by reference in their entirety for all purposes.

### BACKGROUND OF THE INVENTION

In a current sidelink (SL, also be referred to as Side-Link), when determining a transmission resource, a user equipment (UE) first determines a candidate resource set by performing resource exclusion, and then randomly selects a transmission resource from the candidate resource set by performing resource selection.

### SUMMARY OF THE INVENTION

The present disclosure proposes a method and device for resource selection.

A method for resource selection is provided, which is performed by a first user equipment (UE). The method includes: receiving channel occupancy time (COT) sharing information from a second UE; determining, according to at least one of the COT sharing information received from the second UE or a preset threshold, whether the first UE can share a COT indicated by the COT sharing information; and selecting, in a case where the first UE can share the COT, a transmission resource for the first UE from a first time window, where the first time window is a time window that the first UE can use within the COT.

A communication device is provided, including: a memory; and one or more processors, where the one or more processors are collectively configured to: receive channel occupancy time (COT) sharing information from a second UE; determine, according to at least one of the COT sharing information or a preset threshold, whether the first UE can share a COT indicated by the COT sharing information; and select, in a case where the first UE can share the COT, a transmission resource for the first UE from a first time window, wherein the first time window is a time window that the first UE can use within the COT.

A communication system is provided, including a first user equipment (UE) and a second UE, where the first UE is configured to: receive channel occupancy time (COT) sharing information from a second UE; determine, according to at least one of the COT sharing information or a preset threshold, whether the first UE can share a COT indicated by the COT sharing information; and select, in a case where the first UE can share the COT, a transmission resource for the first UE from a first time window, wherein the first time window is a time window that the first UE can use within the COT.

A non-transitory computer-readable storage medium storing computer-executable instructions is provided, where when the computer-executable instructions are executed by one or more processors, the method for resource selection can be implemented.

Additional aspects and advantages of the present disclosure will be given in part in the following description and in part will become apparent from the following description, or learned through practice of the present disclosure.

### BRIEF DESCRIPTION OF DRAWINGS

The above and/or additional aspects and advantages of the present disclosure will become apparent and easily understood from the following description of the examples in conjunction with the accompanying drawings.

FIG. 1 is a schematic diagram of an architecture of a communication system according to an example of the present disclosure;

FIG. 2 is a flow diagram of a method for resource selection according to an example of the present disclosure;

FIG. 3 is a flow diagram of a method for resource selection according to an example of the present disclosure;

FIG. 4 is a flow diagram of a method for resource selection according to an example of the present disclosure;

FIG. 5 is a schematic diagram of a method for resource selection according to an example of the present disclosure;

FIG. 6 is a schematic diagram of a method for resource selection according to an example of the present disclosure;

FIG. 7 is a flow diagram of a method for resource selection according to an example of the present disclosure;

FIG. 8 is a block diagram of a device for resource selection according to an example of the present disclosure;

FIG. 9 is a schematic structural diagram of a communication device provided in an example of the present disclosure; and

FIG. 10 is a schematic structural diagram of a chip provided in an example of the present disclosure.

### DETAILED DESCRIPTION OF THE INVENTION

Examples of the present disclosure will be described in detail below, examples of which are shown in the accompanying drawings, where throughout the same or similar reference numerals denote the same or similar elements, or elements having the same or similar functions. The following examples described with reference to the accompanying drawings are for example and serve to explain the present disclosure, and should not be construed as limiting the present disclosure.

In order to better understand the method and device for resource selection disclosed in the examples of the present disclosure, a communication system to which the examples of the present disclosure are applicable is first described below.

Referring to FIG. 1, in a scenario where sidelink communication is performed between sidelink communication devices, a network device configures various transmission parameters for data transmission for a sidelink communication device 1. The sidelink communication device 1 is used as a data sending end, and a sidelink communication device 2 is used as a data receiving end, both performing sidelink communication. The links for communication between the network device and the sidelink communication devices are uplink and downlink, and the link between sidelink communication devices is a sidelink.

It can be understood that the wireless communication system shown in FIG. 1 is merely for schematic illustration. The wireless communication system may further include other network devices, such as a core network device, a wireless relay device, and a wireless backhaul device, which are not drawn in FIG. 1. The quantity of network devices and terminals included in the wireless communication system is not limited in the examples of the present disclosure.

It can be further understood that the wireless communication system in the example of the present disclosure is a network that provides a wireless communication function. The wireless communication system may adopt different communication technologies, such as code division multiple access (CDMA), wideband code division multiple access (WCDMA), time division multiple access (TDMA), frequency division multiple access (FDMA), orthogonal frequency-division multiple access (OFDMA), single carrier FDMA (SC-FDMA), and carrier sense multiple access with collision avoidance. Based on the capacity, rate, latency and other factors of different networks, the networks may be categorized as 2G (generation) networks, 3G networks, 4G networks, or future evolution networks, such as 5G networks, which may also be referred to as new radio (NR) networks. For the convenience of description, the present disclosure sometimes simply refers to a wireless communication network as a network.

Further, the network device involved in the present disclosure may also be referred to as a wireless access network device, which may be: a base station, an evolved node B (eNB), a home base station, an access point (AP) in a wireless fidelity (WIFI) system, a wireless relay node, a wireless backhaul node, a transmission point (TP), or a transmission and reception point (TRP), etc., may also be a gNB in an NR system, or may also be a component or part of a device that constitutes a base station, etc. In response to being a vehicle-to-everything (V2X) communication system, the network device may also be a vehicle-mounted device. It is to be understood that the specific technology and the specific device form adopted by the network device are not limited in the examples of the present disclosure.

Further, the terminal involved in the present disclosure may also be referred to as a terminal device, a user equipment (UE), a mobile station (MS), a mobile terminal (MT), etc., which is a device that provides voice and/or data connectivity for users. For example, the terminal may be a handheld device, a vehicle-mounted device, etc. with a wireless connection function. Some examples of terminals at present are: mobile phones, pocket personal computers (PPCs), handheld computers, personal digital assistants (PDAs), laptops, tablets, wearable devices, or vehicle-mounted devices, etc. In addition, in response to being a vehicle-to-everything (V2X) communication system, the terminal equipment may also be a vehicle-mounted device. It is to be understood that the specific technology and the specific device form adopted by the terminal are not limited in the examples of the present disclosure.

The present disclosure relates to the technical field of mobile communications, and in particular, to a method and device for resource selection.

In the present disclosure, the communication scenario of sidelink communication between sidelink communication devices may also be a device to device (D2D) communication scenario. The sidelink communication devices for sidelink communication in the examples of the present disclosure may include various handheld devices, vehicle-mounted devices, wearable devices, computing devices or other processing devices connected to a wireless modem with wireless communication functions, as well as various forms of user equipment (UEs), mobile stations (MSs), terminals, terminal devices, etc. For the convenience of description, the examples of the present disclosure are described using a sidelink communication device as a terminal for example.

It can be understood that the communication system described in the example of the present disclosure is intended to more clearly illustrate the technical solution in the examples of the present disclosure, and does not constitute a limitation on the technical solution provided in the examples of the present disclosure. Those of ordinary skill in the art may learn that with the evolution of the system architecture and the emergence of new business scenarios, the technical solution provided in the examples of the present disclosure is also applicable to similar technical problems.

In a current sidelink (SL), when determining a transmission resource, the user equipment (UE) first determines a candidate resource set by performing resource exclusion, and then randomly selects a transmission resource from the candidate resource set by performing resource selection. However, in a sidelink-unlicense (SL-U), a channel occupancy time (COT) sharing mechanism is introduced, and time-frequency resources can be allocated to the UE within a COT according to the COT sharing mechanism. Under the COT sharing mechanism, how the UE selects the transmission resource has become an urgent problem to be solved.

To this end, the present disclosure proposes a method and device for resource selection, so that the UE may select the transmission resource under the COT sharing mechanism, ensuring reliable data transmission by the UE using the transmission resource, while effectively preventing the failure of the COT sharing mechanism between a COT-initiating UE and the UE.

The method and device for resource selection provided in the present disclosure are described in detail below in conjunction with accompanying drawings.

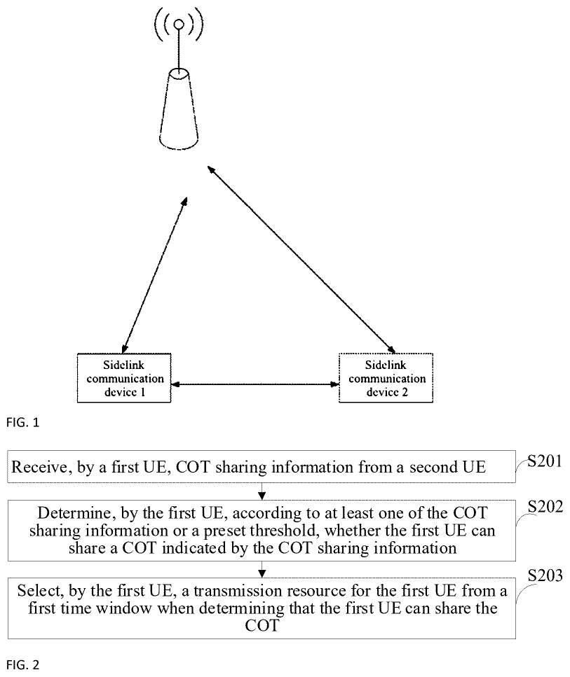

FIG. 2 shows a flow diagram of a method for resource selection according to an example of the present disclosure. As shown in FIG. 2, the method may include the following steps S201-S203.

S201, receive, by a first UE, COT sharing information from a second UE.

In the example, the second UE refers to a COT-initiating UE. Under a COT sharing mechanism, the COT-initiating UE may send COT sharing information to other UEs. The COT sharing information may carry relevant information of a COT shared by the COT-initiating UE and other UEs.

The COT-initiating UE may use CAT1 LBT to initiate one COT, and send the COT sharing information.

S202, determine, by the first UE according to at least one of the COT sharing information or a preset threshold, whether the first UE can share a COT indicated by the COT sharing information.

After receiving the COT sharing information, the first UE may determine, according to at least one of the COT sharing information or the preset threshold, whether the first UE can share the COT indicated by the COT sharing information.

In some implementations, the COT sharing information sent by the second UE may carry an identifier of a UE with which the second UE expects to share resources. For example, if the second UE expects to share resources with the first UE, the second UE may carry the identifier of the first UE in the COT sharing information sent. In this way, after receiving the COT sharing information, the first UE may determine, according to the identifier of the first UE carried, that the COT indicated by the COT sharing information is shared by the second UE and the first UE. If the identifier of the UE carried in the COT sharing information received by the first UE is an identifier of a third UE other than the first UE, the first UE may determine that the COT indicated by the COT sharing information is shared by the second UE and the third UE.

In some implementations, after receiving the COT sharing information, the first UE may determine, according to the preset threshold, whether the first UE can share the COT indicated by the COT sharing information.

The preset threshold may include a reference signal receiving power (RSRP) threshold, a distance threshold, etc.

For example, when the preset threshold is the RSRP threshold, after receiving the COT sharing information, the first UE may determine, according to the RSRP threshold, whether the first UE can share the COT indicated by the COT sharing information. Specifically, the first UE may determine whether an RSRP measured value of a physical sidelink channel corresponding to the COT sharing information is greater than the RSRP threshold, determine that the first UE can share the COT indicated by the COT sharing information when determining that the RSRP measured value is not greater than the RSRP threshold, and determine that the first UE cannot share the COT indicated by the COT sharing information when determining that the RSRP measured value is greater than the RSRP threshold.

For example, when the preset threshold is a distance threshold, after receiving the COT sharing information, the first UE may determine, according to the distance threshold, whether the first UE can share the COT indicated by the COT sharing information. Specifically, the first UE may determine whether a distance between the first UE and the second UE is greater than the distance threshold, determine that the first UE can share the COT indicated by the COT sharing information when determining that the distance is greater than the distance threshold, and determine that the first UE cannot share the COT indicated by the COT sharing information when determining that the distance is not greater than the distance threshold.

S203, select, by the first UE, a transmission resource for the first UE from a first time window when determining that the first UE can share the COT, where the first time window is a time window that the first UE can use within the COT.

When determining that the first UE can share the COT indicated by the COT sharing information, the first UE selects a transmission resource for data transmission from a first time window that the first UE can use within the COT.

The COT indicated by the COT sharing information is also shared by the COT-initiating UE, so that part of the time window within the COT is used by the COT-initiating UE. If the first UE receives COT sharing information sent by the second UE which is the COT-initiating UE and determines that the first UE can share the COT indicated by the COT sharing information, when selecting a transmission resource within the COT, the first UE excludes the resources in the time window that the second UE uses, that is, the first UE selects a resource from the time window that the first UE can use within the COT.

It is to be noted that the present disclosure is applicable to a scenario in which the first UE receives the COT sharing information before resource selection is triggered. In this scenario, since the COT sharing information is received before the resource selection is triggered, the first UE may select the transmission resource according to the COT sharing information when selecting the resource. If the UE does not receive the COT sharing information before the resource selection is triggered, the first UE selects the transmission resource according to a resource selection process in the related art, for example, selects the transmission resource according to the resource selection process in Release 16.

According to the method for resource selection in the example of the present disclosure, the first UE receives COT sharing information from the second UE; determines, according to at least one of the COT sharing information or the preset threshold, whether the first UE can share the COT indicated by the COT sharing information; and when determining that the first UE can share the COT, selects a transmission resource from a time window that the first UE can use within the COT. Thus, according to the method for resource selection in the example, in response to the first UE being capable of sharing the COT, the transmission resource selected by the first UE is a resource allocated to the first UE by the second UE through a COT sharing mechanism, thus effectively preventing the failure of the sharing mechanism between the first UE and the second UE, while ensuring reliable data transmission by the first UE using transmission data.

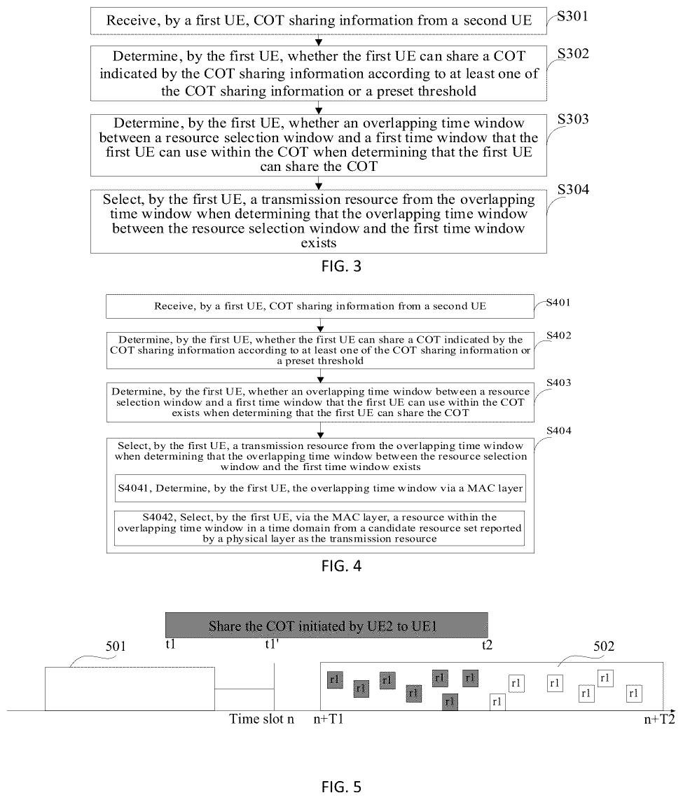

FIG. 3 shows a flow diagram of a method for resource selection according to an example of the present disclosure. As shown in FIG. 3, the method may include the following steps S301-S304.

S301, receive, by a first UE, COT sharing information from a second UE.

S302, determine, by the first UE, whether the first UE can share a COT indicated by the COT sharing information according to at least one of the COT sharing information or a preset threshold.

For the description and specific details of the above steps S301-S302, reference may be made to the relevant description and details of the above steps S201-S202.

S303, determine, by the first UE, whether an overlapping time window between a resource selection window and a first time window that the first UE can use within the COT exists when determining that the first UE can share the COT.

It is worth noting that in the related art, when performing resource selection according to related technologies such as Release 16, the UE first determines a candidate resource set by performing resource exclusion, and then randomly selects a transmission resource from the candidate resource set by performing resource selection. Specifically, when performing resource selection, the resource selection window may be determined first, the candidate resource set located in the resource selection window may be then determined, and a resource selected from the candidate resource set may be used as the transmission resource.

According to the example of the present disclosure, in response to receiving the COT sharing information before the resource selection is triggered and determining that the first UE can share the COT indicated by the COT sharing information, the first UE may determine whether an overlapping time window between the resource selection window and the first time window that the first UE can use within the COT exists.

S304, select, by the first UE, a transmission resource from the overlapping time window when determining that the overlapping time window between the resource selection window and the first time window exists.

When determining that the overlapping time window between the resource selection window and the first time window exists by the first UE, the first UE selects a transmission resource from the overlapping time window. Thus, the selected resource is located within the resource selection window and the first time window in the time domain.

In other examples, when the overlapping time window between the resource selection window and the first time window does not exist by the first UE, the first UE will not consider the resource selection window, that is, the first UE selects a resource from the first time window. That is, the selected resource may not be within the resource selection window but within the first time window in the time domain.

According to the method for resource selection in the example of the present disclosure, the first UE receives COT sharing information from the second UE; determines, according to at least one of the COT sharing information or the preset threshold, whether the first UE can share a COT indicated by the COT sharing information. When determining that the first UE can share the COT, the first UE determines whether an overlapping time window between the resource selection window and the first time window that the first UE can use within the COT exists. When determining that the overlapping time window, the first UE selects a transmission resource from the overlapping time window. Thus, according to the method for resource selection in the example, in response to the first UE being capable of sharing the COT, the transmission resource selected by the first UE is a resource allocated to the first UE by the second UE through a COT sharing mechanism, thus effectively preventing the failure of the sharing mechanism between the first UE and the second UE, while ensuring reliable data transmission by the first UE using transmission data.

FIG. 4 shows a flow diagram of a method for resource selection according to an example of the present disclosure. As shown in FIG. 4, the method may include the following steps S401-S404.

S401, receive, by a first UE, COT sharing information from a second UE.

S402, determine, by a first UE, whether the first UE can share a COT indicated by the COT sharing information according to at least one of the COT sharing information or a preset threshold.

S403, determine, by the first UE, whether an overlapping time window between a resource selection window and a first time window that the first UE can use within the COT exists when determining that the first UE can share the COT.

For the description and specific details of the steps S401-S403, reference may be made to the relevant description and details of the steps S301-S303.

S404, select, by the first UE, a transmission resource from the overlapping time window when determining that an overlapping time window between the resource selection window and the first time window exists.

For the description and specific details of the step S404, reference may be made to the relevant description and details of the step S304.

In some examples, the step S404 may include the following steps S4041-S4042.

S4041, determine, by the first UE, the overlapping time window via a medium access control (MAC) layer.

S4042, select, by the first UE, via the MAC layer, a resource within the overlapping time window in a time domain from a candidate resource set reported by a physical layer as the transmission resource, where the candidate resource set is determined by the physical layer through resource sensing.

The first UE may select, at the MAC layer, a transmission resource for data transmission. Specifically, the MAC layer may determine the overlapping time window between the resource selection window and the first time window, and select a resource within the overlapping time window in the time domain from the candidate resource set reported by the physical layer as the transmission resource.

The candidate resource set may be determined by the first UE according to a resource selection process in Release 16. The specific process may refer to the relevant description of Release 16 and will not be repeated here.

In some examples, the MAC layer may determine an overlapping time window through the following steps: when transmitting the COT sharing information via a MAC control unit, determining the first time window via the MAC layer according to pre-configuration information and the COT sharing information, where the pre-configuration information indicates a time window that the second UE uses within the COT, and the COT sharing information indicates at least one of a remaining length of the COT or a total length of the COT; and determining, via the MAC layer, a later time between a start time of the resource selection window and a start time of the first time window as a start time of the overlapping time window, and an earlier time between an end time of the first time window and an end time of the resource selection window as an end time of the overlapping time window.

The COT sharing information may indicate at least one of a remaining length of the COT or a total length of the COT. The total length of the COT indicates a total length of time windows of the COT, and the remaining length of the COT indicates a length of the first time window that the first UE can use within the COT.

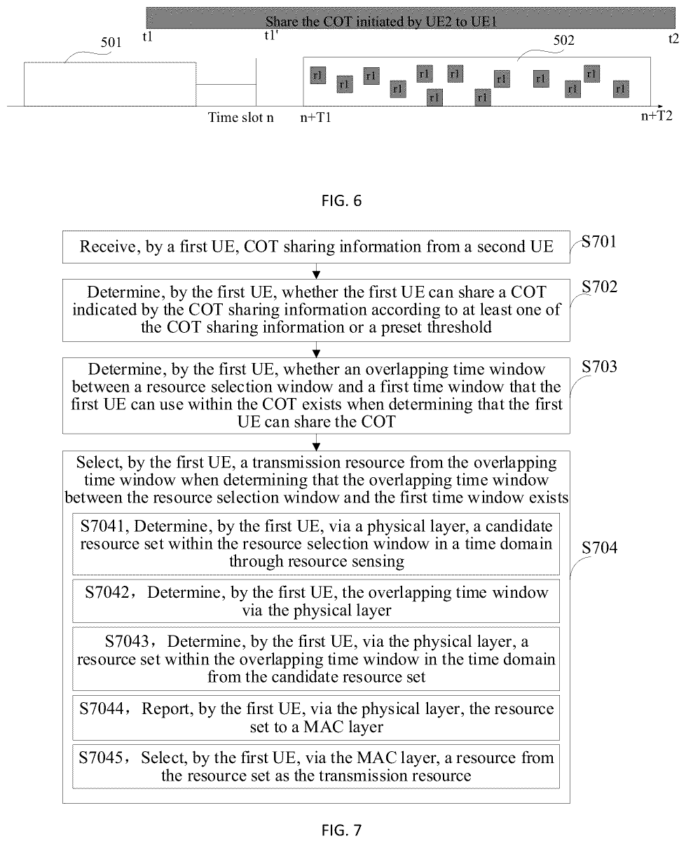

When transmitting the COT sharing information via a media access control control element (MAC CE), the MAC layer may decode, after receiving the COT sharing information, to obtain a time slot in which the second UE, which is a COT-initiating UE, sends the COT sharing information, that is, a start time slot of the COT initiated by the second UE. For example, as shown in FIG. 5 or 6, a start time slot of the COT initiated by a second UE UE2 is t1. In addition, the COT sharing information may indicate that the total length of the COT is L, and the MAC layer may determine that the end position of the COT initiated by the second UE is t1+L, that is, t2 shown in FIG. 5 or 6. Therefore, UE1 may determine at the MAC layer that the time window of the COT initiated by UE2 is [t1, t2]. In addition, the pre-configuration information indicates the time window occupied by UE2 within the COT, and the time window used for UE2 within the COT may be thus determined as [t1, t1′], so that UE1 may determine at the MAC layer that the time window that UE1 can use within the COT is [t1′, t2]. For example, taking a time slot as a unit time, if the pre-configuration information indicates that the time window occupied by UE2 within the COT is 1 time slot, t1′=t1+1; if the pre-configuration information indicates that the time window occupied by UE2 within the COT is m time slots, t1′=t1+m. If the COT sharing information indicates a remaining length L′ of the COT, an end position t2=t1′+L′ of the COT initiated by the second UE may be determined after it is determined that the time window used for UE2 within the COT is [t1, t1′].

For example, the same pre-configuration information may be configured for all UEs in the same cell, that is, each UE in the same cell occupies the same time window within an initiated COT. Certainly, different pieces of pre-configuration information may be configured for different UEs, that is, the time windows occupied by the respective UEs within the initiated COT are different. In this case, the COT-initiating UE needs to send its pre-configuration information to a corresponding UE so that the corresponding UE may determine, according to the pre-configuration information, a time window occupied by the COT-initiating UE within the initiated COT.

After determining the first time window, the MAC layer may determine an overlapping time window between the resource selection window 502 and the first time window.

For example, as shown in FIG. 5 or 6, the resource selection window 502 is [n+T1, n+T2], and the time window that UE1 can use within the COT is [t1′, t2], in which case, the overlapping time window between the resource selection window 502 and the time window that UE1 can use within the COT is [t3, t4], where t3=max {n+T1, t1′}, t4=min {n+T2, t2}. In an example shown in FIG. 5, t3=n+T1, and t4=t2. In an example shown in FIG. 6, t3=n+T1, and t4=n+T2.

In some examples, the MAC layer may determine an overlapping time window through the following steps: when transmitting the COT sharing information via sidelink control information (SCI), receiving, via the MAC layer, a start time and an end time reported by the physical layer, where the start time is a later time between a start time of the resource selection window 502 and a start time of the first time window, and the end time is an earlier time between an end time of the first time window and an end time of the resource selection window 502; and determining, via the MAC layer, the start time reported by the physical layer as a start time of the overlapping time window, and the end time reported by the physical layer as an end time of the overlapping time window.

The COT sharing information may indicate at least one of a remaining length of the COT or a total length of the COT. The total length of the COT indicates a total length of time windows of the COT, and the remaining length of the COT indicates a length of the first time window that the first UE can use within the COT.

When transmitting the COT sharing information via SCI, the physical layer may decode, after receiving the COT sharing information, to obtain a time slot in which the second UE, which is the COT-initiating UE, sends the COT sharing information, that is, a start time slot of the COT initiated by the second UE. For example, as shown in FIG. 5 or 6, the start time slot of the COT initiated by the second UE UE2 is t1. In addition, the total length of the COT indicated in the COT sharing information is L, and the physical layer may determine that the end position of the COT initiated by the second UE is t1+L, that is, t2 shown in FIG. 5 or 6. Therefore, UE1 may determine at the MAC layer that the time window of the COT initiated by UE2 is [t1, t2]. In addition, the pre-configuration information indicates the time window occupied by UE2 within the COT, and the time window used for UE2 within the COT may be thus determined as [t1, t1′], so that UE1 may determine at the MAC layer that the time window that UE1 can use within the COT is [t1′, t2]. For example, taking a time slot as a unit time, if the pre-configuration information indicates that the time window occupied by UE2 within the COT is 1 time slot, t1′=t1+1; if the pre-configuration information indicates that the time window occupied by UE2 within the COT is m time slots, t1′=t1+m. If the COT sharing information indicates the remaining length L′ of the COT, the end position t2=t1′+L′ of the COT initiated by the second UE may be determined after it is determined that the time window used for UE2 within the COT is [t1, t1′].

The same or different pieces of pre-configuration information may be configured for different cells.

After determining the time window that the first UE can use within the COT, the physical layer may determine a start time and an end time, where the start time is a later time between a start time of the resource selection window 502 and a start time of the time window that the first UE can use within the COT, and the end time is an earlier time between an end time of the resource selection window 502 and an end time of the time window that the first UE can use within the COT.

For example, as shown in FIG. 5 or 6, the resource selection window 502 is [n+T1, n+T2], and the time window that UE1 can use within the COT is [t1′, t2], in which case, the start time t3=max {n+T1, t1′}, and the end time t4=min {n+T2, t2}. In an example shown in FIG. 5, t3=n+T1, and t4=t2. In an example shown in FIG. 6, t3=n+T1, and t4=n+T2.

The physical layer reports the start time t3 to the MAC layer, and reports the end time t4 to the MAC layer. The MAC layer uses the received start time as a start time of the overlapping time window, and the received end time as an end time of the overlapping time window, thus determining that the overlapping time window is [t3, t4].

According to the method for resource selection in the example of the present disclosure, the first UE receives COT sharing information from the second UE; determines, according to at least one of the COT sharing information or the preset threshold, whether the first UE can share a COT indicated by the COT sharing information; when determining that the first UE can share the COT, determines whether an overlapping time window between the resource selection window 502 and the first time window that the first UE can use within the COT exists; and when determining that the overlapping time window exists, determines the overlapping time window via a MAC layer and selects a transmission resource from the overlapping time window. Thus, according to the method for resource selection in the example, in response to the first UE being capable of sharing the COT, the transmission resource selected by the first UE is a resource allocated to the first UE by the second UE through a COT sharing mechanism, thus effectively preventing the failure of the sharing mechanism between the first UE and the second UE, while ensuring reliable data transmission by the first UE using transmission data

FIG. 7 shows a flow diagram of a method for resource selection according to an example of the present disclosure. As shown in FIG. 7, the method may include the following steps S701-S704.

S701, receive, by a first UE, COT sharing information from a second UE.

S702, determine, by the first UE, whether the first UE can share a COT indicated by the COT sharing information according to at least one of the COT sharing information and a preset threshold.

S703, determine, by the first UE, whether an overlapping time window between a resource selection window and a first time window that the first UE can use within the COT exists when determining that the first UE can share the COT.

For the description and specific details of the above steps S701-S703, reference may be made to the relevant description and details of the above steps S301-S303.

S704, select, by the first UE, a transmission resource from the overlapping time window when determining that the overlapping time window between the resource selection window 502 and the first time window exists.

For the description and specific details of the above step S704, reference may be made to the relevant description and details of the above step S304.

In some examples, the above step S704 may include the following steps S7041-S7045.

S7041, determine, by the first UE, via a physical layer, a candidate resource set within the resource selection window 502 in a time domain through resource sensing. S7042, determine, by the first UE, the overlapping time window via the physical layer.

S7043, determine, by the first UE, via the physical layer, a resource set within the overlapping time window in the time domain from the candidate resource set.

S7044, report, by the first UE, via the physical layer, the resource set to a MAC layer.

S7045, select, by the first UE, via the MAC layer, a resource from the resource set as the transmission resource.

The first UE may determine, at the physical layer, a resource set that can be used as transmission resources, and select a transmission resource from the resource set at the MAC layer. Specifically, the first UE can perform resource sensing by the physical layer through resource sensing window 501. The physical layer may determine the candidate resources set within the resource selection window 502 in the time domain, determine the overlapping time window between the resource selection window 502 and the first time window that the first UE can use within the COT, and determine the resource set within the overlapping time window in the time domain from the candidate resource set and report the resource set to the MAC layer, so that the MAC layer may select the transmission resource from the resource set reported by the physical layer.

The candidate resource set may be determined by the first UE according to a resource selection process in Release 16. The specific process may refer to the relevant description of Release 16 and will not be repeated here.

In some examples, the physical layer may determine the overlapping time window through the following steps: determining the first time window via the physical layer according to pre-configuration information and the COT sharing information, where the pre-configuration information indicates a time window that the second UE uses within the COT, and the COT sharing information indicates at least one of a remaining length of the COT or a total length of the COT; and determining, via the physical layer, a later time between a start time of the resource selection window 502 and a start time of the first time window as a start time of the overlapping time window, and an earlier time between an end time of the first time window and an end time of the resource selection window 502 as an end time of the overlapping time window.

The COT sharing information may indicate at least one of a remaining length of the COT or a total length of the COT. The total length of the COT indicates a total length of time windows of the COT, and the remaining length of the COT indicates a length of the first time window that the first UE can use within the COT.

The physical layer may decode, after receiving the COT sharing information, to obtain a time slot in which the second UE, which is a COT-initiating UE, sends the COT sharing information, that is, a start time slot of the COT initiated by the second UE. For example, as shown in FIG. 5 or 6, the start time slot of the COT initiated by the second UE UE2 is t1. In addition, the total length of the COT indicated in the COT sharing information is L, and the physical layer may determine that the end position of the COT initiated by the second UE is t1+L, that is, t2 shown in FIG. 5 or 6. Therefore, UE1 may determine at the MAC layer that the time window of the COT initiated by UE2 is [t1, t2]. In addition, the pre-configuration information indicates the time window occupied by UE2 within the COT, and thus the time window used for UE2 within the COT may be determined as [t1, t1′], so that UE1 may determine at the MAC layer that the time window that UE1 can use within the COT is [t1′, t2]. For example, taking a time slot as a unit time, if the pre-configuration information indicates that the time window occupied by UE2 within the COT is 1 time slot, t1′=t1+1; if the pre-configuration information indicates that the time window occupied by UE2 within the COT is m time slots, t1′=t1+m. If the COT sharing information indicates the remaining length L′ of the COT, the end position t2=t1′+L′ of the COT initiated by the second UE may be determined after it is determined that the time window used for UE2 within the COT is [t1, t1′].

For example, the same pre-configuration information may be configured for all UEs in the same cell, that is, each UE in the same cell occupies the same time window within an initiated COT. Certainly, different pieces of pre-configuration information may be configured for different UEs, that is, the time windows occupied by the respective UEs within the initiated COT are different. In this case, the COT-initiating UE needs to send its pre-configuration information to a corresponding UE so that the corresponding UE may determine, according to the pre-configuration information, a time window occupied by the COT-initiating UE within the initiated COT.

After determining the first time window, the physical layer may determine the overlapping time window between the resource selection window 502 and the first time window.

For example, as shown in FIG. 5 or 6, the resource selection window 502 is [n+T1, n+T2], and the time window that UE1 can use within the COT is [t1′, t2], in which case, the overlapping time window between the resource selection window 502 and the time window that UE1 can use within the COT is [t3, t4], where t3=max {n+T1, t1′}, t4=min {n+T2, t2}. In an example shown in FIG. 5, t3=n+T1, and t4=t2. In an example shown in FIG. 6, t3=n+T1, and t4=n+T2.

After determining the overlapping time window, the physical layer may determine a resource set within the overlapping time window in the time domain from the candidate resource set, and report the resource set to the MAC layer so that the MAC layer selects a resource from the resource set as the transmission resource. UE1 preferentially selects gray resources r1 in the candidate resource sets because the gray resources r1 are located within the COT. For example, the physical layer reports a set of gray resources r1 in FIG. 5 or 6 to the MAC layer, so that the MAC layer may select a transmission resource from the set.

According to the method for resource selection in the example of the present disclosure, the first UE receives COT sharing information from the second UE; determines, according to at least one of the COT sharing information or the preset threshold, whether the first UE can share a COT indicated by the COT sharing information; when determining that the first UE can share the COT, determines whether an overlapping time window between the resource selection window 502 and the first time window that the first UE can use within the COT exists; and when determining that the overlapping time window exists, determines a resource set within the overlapping time window in the time domain from the candidate resource set via the physical layer and reports the resource set to the MAC layer so that the MAC layer selects a transmission resource from the resource set. Thus, according to the method for resource selection in the example, in response to the first UE being capable of sharing the COT, the transmission resource selected by the first UE is a resource allocated to the first UE by the second UE through a COT sharing mechanism, thus effectively preventing the failure of the sharing mechanism between the first UE and the second UE, while ensuring reliable data transmission by the first UE using transmission data.

In the above examples provided in the present disclosure, the method provided in the example of the present disclosure is introduced from the perspective of a user equipment. In order to implement various functions in the above method provided in the example of the present disclosure, the user equipment may include a hardware structure and a software module, and implement the above various functions in the form of the hardware structure, the software module, or the hardware structure plus the software module. Any of the above various functions may be implemented by the hardware structure, the software module, or the hardware structure plus the software module.

Corresponding to the method for resource selection provided in the above several examples, the present disclosure also provides a device for resource selection. Since the device for resource selection provided in the example of the present disclosure corresponds to the method for resource selection provided in the above several examples, the implementation of the method for resource selection is also applicable to the device for resource selection provided in the example and will not be described in detail in the example.

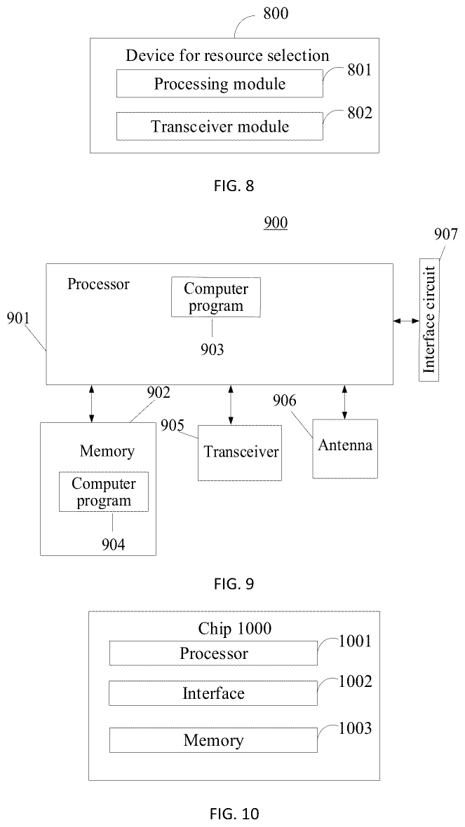

FIG. 8 is a schematic structural diagram of a device 800 for resource selection provided in an example of the present disclosure. The device 800 for resource selection may be a first UE.

As shown in FIG. 8, the device 800 for resource selection may include a transceiver module 802 and a processing module 801.

The transceiver module 802 is configured to receive channel occupancy time (COT) sharing information from the second UE.

The processing module 801 is configured to determine, according to at least one of the COT sharing information or a preset threshold, whether the device for resource selection can share a COT indicated by the COT sharing information; and select, when determining that the device for resource selection can share the COT, a transmission resource for the device for resource selection from a first time window, where the first time window is a time window that the device for resource selection can use within the COT.

According to the device for resource selection in the example of the present disclosure, the first UE receives COT sharing information from the second UE; determines, according to at least one of the COT sharing information or the preset threshold, whether the first UE can share a COT indicated by the COT sharing information; and selects, when determining that the first UE can share the COT, the transmission resource from a time window that the first UE can use within the COT. Thus, according to the device for resource selection in the example, in response to the first UE being capable of sharing the COT, the transmission resource selected by the first UE is a resource allocated to the first UE by the second UE through a COT sharing mechanism, thus effectively preventing the failure of the sharing mechanism between the first UE and the second UE, while ensuring reliable data transmission by the first UE using transmission data.

In some examples, the processing module 801 is further configured to: determine whether an overlapping time window between a resource selection window and the first time window exists; and select, when determining that the overlapping time window between the resource selection window and the first time window exists, the transmission resource from the overlapping time window.

In some examples, the processing module 801 is further configured to: determine the overlapping time window via a medium access control (MAC) layer; and select, via the MAC layer, a resource within the overlapping time window in a time domain from a candidate resource set reported by a physical layer as the transmission resource, where the candidate resource sets are determined by the physical layer through resource sensing.

In some examples, the processing module 801 is further configured to: determine, via the physical layer, a candidate resource set within the resource selection window in a time domain through resource sensing; determine the overlapping time window via the physical layer; and determine, via the physical layer, a resource set within the overlapping time window in the time domain from the candidate resource set.

The transceiver module 802 is further configured to report, through the physical layer, the resource set to a MAC layer.

The processing module 801 is further configured to select, via the MAC layer, a resource from the resource set as the transmission resource.

In some examples, the processing module 801 is further configured to: determine, when transmitting the COT sharing information via a MAC control unit, the first time window via the MAC layer according to pre-configuration information and the COT sharing information, where the pre-configuration information indicates a second time window that the second UE uses within the COT, and the COT sharing information indicates at least one of a remaining length of the COT or a total length of the COT, where the remaining length of the COT indicates a length of the first time window, and the total length of the COT indicates a sum of a length of the first time window and a length of the second time window; and determine, via the MAC layer, a later time between a start time of the resource selection window and a start time of the first time window as a start time of the overlapping time window, and an earlier time between an end time of the first time window and an end time of the resource selection window as an end time of the overlapping time window.

In some examples, the processing module 801 is further configured to: receive, via the MAC layer, when transmitting the COT sharing information via sidelink control information (SCI), a start time and an end time reported by the physical layer, where the start time is a later time between a start time of the resource selection window and a start time of the first time window determined by the physical layer, and the end time is an earlier time between an end time of the first time window and an end time of the resource selection window; and determine, via the MAC layer, the start time reported by the physical layer as a start time of the overlapping time window, and the end time reported by the physical layer as an end time of the overlapping time window.

In some examples, the processing module 801 is further configured to: determine the first time window via the physical layer according to pre-configuration information and the COT sharing information, where the pre-configuration information indicates a second time window that the second UE uses within the COT, and the COT sharing information indicates at least one of a remaining length of the COT or a total length of the COT, where the remaining length of the COT indicates a length of the first time window, and the total length of the COT indicates a sum of a length of the first time window and a length of the second time window; and determine, via the physical layer, a later time between a start time of the resource selection window and a start time of the first time window as a start time of the overlapping time window, or an earlier time between an end time of the first time window and an end time of the resource selection window as an end time of the overlapping time window.

The present disclosure proposes a method and device for resource selection, so that a UE may select a transmission resource under a COT sharing mechanism, ensuring reliable data transmission by the UE using the transmission resource to perform, while effectively preventing the failure of the COT sharing mechanism between a COT-initiating UE and the UE.

In an example of a first aspect of the present disclosure a method for resource selection is provided, which is performed by a first user equipment (UE). The method includes: receiving channel occupancy time (COT) sharing information from a second UE; determining, according to at least one of the COT sharing information received from the second UE or a preset threshold, whether the first UE can share a COT indicated by the COT sharing information; and selecting, when determining that the first UE can share the COT, a transmission resource for the first UE from a first time window, where the first time window is a time window that the first UE can use within the COT.

Optionally, selecting the transmission resource for the first UE from the first time window includes: determining whether an overlapping time window between a resource selection window and the first time window exists; and selecting the transmission resource from the overlapping time window when determining that the overlapping time window between the resource selection window and the first time window exists.

Optionally, selecting the transmission resource from the overlapping time window includes: determining the overlapping time window via a medium access control (MAC) layer;

and selecting, via the MAC layer, a resource within the overlapping time window in a time domain from a candidate resource set reported by a physical layer as the transmission resource, where the candidate resource sets are determined by the physical layer through resource sensing.

Optionally, selecting the transmission resource from the overlapping time window includes: determining, via a physical layer, a candidate resource set within the resource selection window in a time domain through resource sensing; determining the overlapping time window via the physical layer; determining, via the physical layer, a resource set within the overlapping time window in the time domain from the candidate resource set; reporting, via the physical layer, the resource set to a MAC layer; and selecting, via the MAC layer, a resource from the resource set as the transmission resource.

Optionally, determining the overlapping time window via the MAC layer includes: determining, when transmitting the COT sharing information via a MAC control unit, the first time window via the MAC layer according to pre-configuration information and the COT sharing information, where the pre-configuration information indicates a second time window used by the second UE within the COT, and the COT sharing information indicates a remaining length of the COT and/or a total length of the COT, where the remaining length of the COT indicates a length of the first time window, and the total length of the COT indicates a sum of a length of the first time window and a length of the second time window; and determining, via the MAC layer, a later time between a start time of the resource selection window and a start time of the first time window as a start time of the overlapping time window, and an earlier time between an end time of the first time window and an end time of the resource selection window as an end time of the overlapping time window.

Optionally, determining the overlapping time window via the MAC layer includes: receiving, via the MAC layer, when transmitting the COT sharing information via sidelink control information (SCI), a start time and an end time reported by the physical layer, where the start time is a later time between a start time of the resource selection window and a start time of the first time window, and the end time is an earlier time between an end time of the first time window and an end time of the resource selection window; and determining, via the MAC layer, the start time reported by the physical layer as a start time of the overlapping time window, and the end time reported by the physical layer as an end time of the overlapping time window.

Optionally, determining the overlapping time window via the physical layer includes: determining the first time window via the physical layer according to pre-configuration information and the COT sharing information, where the pre-configuration information indicates a second time window used by the second UE within the COT, and the COT sharing information indicates a remaining length of the COT and/or a total length of the COT, where the remaining length of the COT indicates a length of the first time window, and the total length of the COT indicates a sum of a length of the first time window and a length of the second time window; and determining, via the physical layer, a later time between a start time of the resource selection window and a start time of the first time window as a start time of the overlapping time window, and an earlier time between an end time of the first time window and an end time of the resource selection window as an end time of the overlapping time window.

In an example of a second aspect of the present disclosure, a device for resource selection is provided, including: a transceiver module, configured to receive channel occupancy time (COT) sharing information from a second user equipment (UE); and a processing module, configured to determine, according to at least one of the COT sharing information or a preset threshold, whether the device for resource selection can share a COT indicated by the COT sharing information; and select, when determining that the device for resource selection can share the COT, a transmission resource for the device for resource selection from a first time window, where the first time window is a time window that the device for resource selection can use within the COT.

Optionally, the processing module is further configured to: determine whether an overlapping time window between a resource selection window and the first time window exists; and select, when determining that the overlapping time window between the resource selection window and the first time window exists, the transmission resource from the overlapping time window.

Optionally, the processing module is further configured to: determine the overlapping time window via a medium access control (MAC) layer; and select, via the MAC layer, a resource within the overlapping time window in a time domain from a candidate resource set reported by a physical layer as the transmission resource, where the candidate resource set is determined by the physical layer through resource sensing.

Optionally, the processing module is further configured to: determine, via a physical layer, a candidate resource set within the resource selection window in a time domain through resource sensing; determine the overlapping time window via the physical layer; and determine, via the physical layer, a resource set within the overlapping time window in the time domain from among the candidate resource set; the transceiver module is further configured to report, via the physical layer, the resource set to a MAC layer; and the processing module is further configured to select, via the MAC layer, a resource from the resource set as the transmission resource.

Optionally, the processing module is further configured to: determine, when transmitting the COT sharing information via a MAC control unit, the first time window via the MAC layer according to pre-configuration information and the COT sharing information, where the pre-configuration information indicates a second time window used by the second UE within the COT, and the COT sharing information indicates a remaining length of the COT and/or a total length of the COT, where the remaining length of the COT indicates a length of the first time window, and the total length of the COT indicates a sum of a length of the first time window and a length of the second time window; and determine, via the MAC layer, a later time between a start time of the resource selection window and a start time of the first time window as a start time of the overlapping time window, and an earlier time between an end time of the first time window and an end time of the resource selection window as an end time of the overlapping time window.

Optionally, the processing module is further configured to: receive, when transmitting the COT sharing information by sidelink control information (SCI), via the MAC layer, a start time and an end time reported by the physical layer, where the start time is a later time between a start time of the resource selection window and a start time of the first time window determined by the physical layer, and the end time is an earlier time between an end time of the first time window and an end time of the resource selection window; and determine, via the MAC layer, the start time reported by the physical layer as a start time of the overlapping time window, and the end time reported by the physical layer as an end time of the overlapping time window.

Optionally, the processing module is further configured to: determine the first time window via the physical layer according to pre-configuration information and the COT sharing information, where the pre-configuration information indicates a second time window used by the second UE within the COT, and the COT sharing information indicates a remaining length of the COT and/or a total length of the COT, where the remaining length of the COT indicates a length of the first time window, and the total length of the COT indicates a sum of a length of the first time window and a length of the second time window; and determine, via the physical layer, a later time between a start time of the resource selection window and a start time of the first time window as a start time of the overlapping time window, or an earlier time between an end time of the first time window and an end time of the resource selection window as an end time of the overlapping time window.

In an example of a third aspect of the present disclosure, a communication device is provided, including: a transceiver; a memory; and a processor, where the processor is connected to the transceiver and the memory, is configured to control wireless signal reception and transmission of the transceiver by executing computer-executable instructions on the memory, and can implement the above method for resource selection in the example of the first aspect.

In an example of a fourth aspect of the present disclosure, a system is provided, including a first user equipment (UE) and a second UE, where the first UE is configured to perform the above method for resource selection in the example of the first aspect. In an example of a fifth aspect of the present disclosure, a computer storage medium storing computer-executable instructions is provided, where when the computer-executable instructions are executed by a processor, the above method for resource selection in the example of the first aspect can be implemented.

An example of the present disclosure provides a method and device for resource selection. The first UE receives COT sharing information from the second UE; determines, according to the COT sharing information and/or the preset threshold, whether the first UE can share a COT indicated by the COT sharing information; and when determining that the first UE can share the COT, selects the transmission resource from the time window that the first UE can share within the COT. Thus, according to the method for resource selection of the present disclosure, when the first UE can share the COT, the transmission resource selected by the first UE is a resource allocated to the first UE by the second UE through a COT sharing mechanism, thus effectively preventing the failure of the sharing mechanism between the first UE and the second UE, while ensuring reliable data transmission by the first UE using transmission data.

An example of the present disclosure also provides a system, including a first UE and a second UE. The second UE is configured to send COT sharing information to the first UE, so as to allocate, through the COT sharing information, resources within a COT indicated by the COT sharing information to the first UE. The first UE is configured to perform the method for resource selection described above with reference to FIGS. 2 to 7.

Referring to FIG. 9, FIG. 9 is a schematic structural diagram of a communication device 900 provided in an example of the present disclosure. The communication device 900 may be a network device, or a user equipment, or a chip, chip system, or processor, etc. that supports the network device to implement the above method, or a chip, chip system, or processor, etc. that supports the user equipment to implement the above method. The device may be used to implement the method described in the above method examples, and reference may be made to the description in the above method examples for details.

The communication device 900 may include one or more processors 901, which may be a general-purpose processor or a special-purpose processor, etc. For example, the processor 901 may be a baseband processor or a central processing unit. The baseband processor may be configured to process communication protocols and communication data. The central processing unit may be configured to control a communication device (such as a base station, a baseband chip, terminal equipment, a terminal equipment chip, a DU or a CU, etc.), to execute computer programs, and process computer program data.

Optionally, the communication device 900 may also include one or more memories 902, on which a computer program 904 may be stored. The processor 901 executes the computer program 904, so that the communication device 900 performs the method described in the above method examples. Optionally, data may also be stored in the memory 902. The communication device 900 and the memory 902 may be provided separately or integrated together.

Optionally, the communication device 900 may also include a transceiver 905 and an antenna 906. The transceiver 905 may be referred to as a transceiver unit, a transceiver device, or a transceiver circuit, etc., and is configured to implement transceiver functions. The transceiver 905 may include a receiver and a transmitter. The receiver may be referred to as a receiving device or a receiving circuit, etc., and is configured to implement a receiving function; the transmitter may be referred to as a transmitting device or a transmitting circuit, etc., and is configured to implement a transmitting function.

Optionally, the communication device 900 may also include one or more interface circuits 907 configured to receive code instructions and transmit the code instructions to the processor 901. The processor 901 runs the code instructions to enable the communication device 900 to perform the method described in the above method examples.

In an implementation, the processor 901 may include a transceiver for implementing receiving and transmitting functions. For example, the transceiver may be a transceiver circuit, or an interface, or an interface circuit. The transceiver circuit, interface or interface circuit configured to implement the receiving and transmitting functions may be separate or integrated together. The above transceiver circuit, interface or interface circuit may be used for reading and writing codes/data, or the above transceiver circuit, interface or interface circuit may be used for transmitting or transferring signals.

In an implementation, the processor 901 may store a computer program 903, which runs on the processor 901 to enable the communication device 900 to perform the method described in the above method examples. The computer program 903 may be solidified in the processor 901. In this case, the processor 901 may be implemented by hardware.

In an implementation, the communication device 900 may include a circuit, which may implement the function of transmitting or receiving or communicating in the above method examples. The processor and transceiver described in the present disclosure may be implemented on an integrated circuit (IC), an analog IC, a radio frequency integrated circuit (RFIC), a mixed signal IC, an application specific integrated circuit (ASIC), a printed circuit board (PCB), an electronic device, etc. The processor and the transceiver may also be manufactured using various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), a silicon germanium (SiGe), and a gallium arsenide (GaAs).

The communication device described in the above examples may be a network device or a user equipment, but the scope of the communication device described in the present disclosure is not limited thereto, and the structure of the communication device may not be limited to FIG. 9. The communication device may be a stand-alone device or part of a larger device. The communication device, for example, may be: (1) a stand-alone integrated circuit (IC), or a chip, or a system or subsystem on chips; (2) a set having one or more ICs, and optionally, the IC set may further include a storage component configured to store data and computer programs; (3) an ASIC, such as a modem; (4) a module that can be embedded in other devices; (5) a receiver, a terminal equipment, an intelligent terminal equipment, a cellular phone, a wireless device, a handheld device, a mobile unit, a vehicle-mounted device, a network device, a cloud device, an artificial intelligence device, etc.; and (6) others.

In a case where the communication device may be a chip or a chip system, reference may be made to a schematic structural diagram of the chip shown in FIG. 10. The chip 1000 shown in

FIG. 10 includes a processor 1001 and an interface 1002. There may be one or more processors 1001, and there may be a plurality of interfaces 1002.

Optionally, the chip 1000 further includes a memory 1003, which is configured to store necessary computer programs and data.

Those skilled in the art may also understand that the various illustrative logical blocks and steps listed in the examples of the present disclosure may be implemented by electronic hardware, computer software, or a combination of both. Whether such functionality is implemented through hardware or software depends on specific applications and the design requirements of the entire system. Those skilled in the art may use various methods to implement the functions for each specific application, but such implementation is not to be understood as exceeding the scope of protection of the examples of the present disclosure.

The present disclosure further provides a readable storage medium having instructions stored thereon. The functions in any of the above method examples are implemented when the instructions are executed by a computer.

The present disclosure also provides a computer program product. The functions in any of the above method examples are implemented when the computer program product is executed by a computer.

All or part of the above examples may be implemented by software, hardware, firmware or any combination thereof. When implemented by software, all or part of the above examples may be implemented in the form of a computer program product which includes one or more computer programs. When the computer program is loaded and executed on a computer, the processes or functions described according to the examples of the present disclosure are generated in whole or in part. The computer may be a general-purpose computer, a special-purpose computer, a computer network, or other programmable device. The computer program may be stored in a computer-readable storage medium, or transmitted from one computer-readable storage medium to another. For example, the computer program may be transmitted from one website, computer, server or data center to another website, computer, server or data center by wired (e.g., coaxial cable, optical fiber, digital subscriber line (DSL)) or wireless (e.g., infrared, wireless, microwave, etc.) means. The computer-readable storage medium may be any available medium that a computer can access or a data storage device such as a server or a data center that includes one or more available media integrated. The available medium may be a magnetic medium (e.g., a floppy disk, a hard disk, a magnetic tape), an optical medium (e.g., a high-density digital video disc (DVD)), or a semiconductor medium (e.g., a solid state disk (SSD)), etc.

Those of ordinary skill in the art may understand that the various numerical numbers such as first and second involved in the present disclosure are distinguished merely for the convenience of description and are not used to limit the scope of the examples of the present disclosure, and also indicate the order of precedence.

At least one in the present disclosure may also be described as one or more, and a plurality of may be two, three, four or more, which is not limited in the present disclosure. In the examples of the present disclosure, technical features in a technical feature are distinguished by “first”, “second”, “third”, “A”, “B”, “C”, “D”, etc., and there is no order of precedence or size between the technical features described by the “first”, “second”, “third”, “A”, “B”, “C” and “D”.

As used in the present disclosure, the terms “machine-readable medium” and “computer-readable medium” refer to any computer program product, device, and/or apparatus (e.g., disk, optical disk, memory, programmable logic device (PLD)) for providing machine instructions and/or data to a programmable processor, including a machine-readable medium that receives machine instructions as machine-readable signals. The term “machine-readable signal” refers to any signal used to provide machine instructions and/or data to a programmable processor.

The system and techniques described in the present disclosure may be implemented in a computing system (e.g., as a data server) that includes back-end components, or a computing system (e.g., an application server) that includes middleware components, or a computing system (e.g., a user computer with a graphical user interface or a web browser through which a user may interact with implementations of the system and techniques described herein) that includes front-end components, or a computing system that includes any combination of such back-end components, middleware components, or front-end components. The components of the system may be interconnected by any form or medium of digital data communication (e.g., a communication network). Examples of communication networks include: a local area network (LAN), a wide area network (WAN), and the Internet.

A computer system may include a client and a server which are generally remote from each other and typically interact via a communication network. The relationship of the client and the server arises by computer programs running on respective computers and having a client-server relationship to each other.

It is to be understood that various forms of the processes shown above may be used, with steps reordered, added or deleted. For example, the various steps described in the present disclosure may be executed in parallel, sequentially, or in a different order, as long as the expected results of the technical solution disclosed in the present disclosure can be achieved, which is not limited here.

In addition, it is to be understood that the various examples described in the present disclosure may be implemented individually or in combination with other examples when the solution permits.

Those of ordinary skill in the art may appreciate that the units and algorithm steps of each example described in conjunction with the examples disclosed may be implemented by electronic hardware, or a combination of computer software and electronic hardware. Whether these functions are performed in hardware or software depends on specific applications and design constraints of the technical solution. Professional technicians may use different methods to implement the described functions for each specific application, but such implementation is not to be considered to be beyond the scope of the present disclosure.

Those skilled in the art may clearly understand that, for the convenience and brevity of description, specific working processes of the systems, apparatuses and units described above may refer to corresponding processes in the above method examples and will not be repeated here.

The above description is merely a specific implementation of the present disclosure, but the scope of protection of the present disclosure is not limited here. Changes or substitutions that any technician familiar with the technical field may be readily conceivable of within the technical scope disclosed in the present disclosure shall be included in the scope of protection of the present disclosure. Therefore, the scope of protection of the present disclosure shall be based on the scope of protection of the claims.

1. A method for resource selection, performed by a first user equipment (UE), comprising:
receiving channel occupancy time (COT) sharing information from a second UE;
determining, according to at least one of the COT sharing information or a preset threshold, whether the first UE can share a COT indicated by the COT sharing information; and
selecting, in a case where the first UE can share the COT, a transmission resource for the first UE from a first time window, wherein the first time window is a time window that the first UE can use within the COT.

2. The method according to claim 1, wherein selecting the transmission resource for the first UE from the first time window comprises:
determining whether an overlapping time window between a resource selection window and the first time window exists; and
selecting the transmission resource from the overlapping time window when the overlapping time window between the resource selection window and the first time window exists.

3. The method according to claim 2, wherein selecting the transmission resource from the overlapping time window comprises:
determining the overlapping time window via a medium access control (MAC) layer; and
selecting, via the MAC layer, a resource within the overlapping time window in a time domain from a candidate resource set reported by a physical layer as the transmission resource, wherein the candidate resource set is determined by the physical layer through resource sensing.

4. The method according to claim 2, wherein selecting the transmission resource from the overlapping time window comprises:
determining, via a physical layer, a candidate resource set within the resource selection window in a time domain through resource sensing;
determining the overlapping time window via the physical layer;
determining, via the physical layer, a resource set within the overlapping time window in the time domain from the candidate resource set;
reporting, via the physical layer, the resource set to a MAC layer; and
selecting, via the MAC layer, a resource from the resource set as the transmission resource.

5. The method according to claim 3, wherein determining the overlapping time window via the MAC layer comprises:
determining, when transmitting the COT sharing information via a MAC control unit, the first time window via the MAC layer according to pre-configuration information and the COT sharing information, wherein the pre-configuration information indicates a second time window used by the second UE within the COT, and the COT sharing information indicates at least one of a remaining length of the COT or a total length of the COT, wherein the remaining length of the COT indicates a length of the first time window, and the total length of the COT indicates a sum of a length of the first time window and a length of the second time window; and
determining, via the MAC layer, a later time between a start time of the resource selection window and a start time of the first time window as a start time of the overlapping time window, and an earlier time between an end time of the first time window and an end time of the resource selection window as an end time of the overlapping time window.

6. The method according to claim 3, wherein determining the overlapping time window via the MAC layer comprises:
receiving, via the MAC layer, when transmitting the COT sharing information via sidelink control information (SCI), a start time and an end time reported by the physical layer, wherein the start time is a later time between a start time of the resource selection window and a start time of the first time window, and the end time is an earlier time between an end time of the first time window and an end time of the resource selection window; and
determining, via the MAC layer, the start time reported by the physical layer as a start time of the overlapping time window, and the end time reported by the physical layer as an end time of the overlapping time window.

7. The method according to claim 4, wherein determining the overlapping time window via the physical layer comprises:
determining the first time window via the physical layer according to pre-configuration information and the COT sharing information, wherein the pre-configuration information indicates a second time window used by the second UE within the COT, and the COT sharing information indicates at least one of a remaining length of the COT or a total length of the COT, wherein the remaining length of the COT indicates a length of the first time window, and the total length of the COT indicates a sum of a length of the first time window and a length of the second time window; and
determining, via the physical layer, a later time between a start time of the resource selection window and a start time of the first time window as a start time of the overlapping time window, and an earlier time between an end time of the first time window and an end time of the resource selection window as an end time of the overlapping time window.

8-14. (canceled)

15. A communication device, comprising:
a memory; and one or more processors, wherein the one or more processors are collectively configured to:
receive channel occupancy time (COT) sharing information from a second UE;
determine, according to at least one of the COT sharing information or a preset threshold, whether the first UE can share a COT indicated by the COT sharing information; and
select, in a case where the first UE can share the COT, a transmission resource for the first UE from a first time window, wherein the first time window is a time window that the first UE can use within the COT.

16. A communication system, comprising:
a first user equipment (UE); and
a second UE, wherein the first UE is configured to:
receive channel occupancy time (COT) sharing information from the second UE;
determine, according to at least one of the COT sharing information or a preset threshold, whether the first UE can share a COT indicated by the COT sharing information; and
select, in a case where the first UE can share the COT, a transmission resource for the first UE from a first time window, wherein the first time window is a time window that the first UE can use within the COT.

17. A non-transitory computer-readable storage medium storing computer-executable instructions, wherein when the computer-executable instructions are executed by one or more processors, the method according to claim 1 is implemented.

18. The communication device according to claim 15, the one or more processors are collectively configured to:
determine whether an overlapping time window between a resource selection window and the first time window exists; and
select the transmission resource from the overlapping time window in a case where the overlapping time window between the resource selection window and the first time window exists.

19. The communication device according to claim 18, the one or more processors are collectively configured to:
determine the overlapping time window via a medium access control (MAC) layer; and
select, via the MAC layer, a resource within the overlapping time window in a time domain from a candidate resource set reported by a physical layer as the transmission resource, wherein the candidate resource set is determined by the physical layer through resource sensing.

20. The communication device according to claim 18, the one or more processors are collectively configured to:
determine, via a physical layer, a candidate resource set within the resource selection window in a time domain through resource sensing;
determine the overlapping time window via the physical layer;
determine, via the physical layer, a resource set within the overlapping time window in the time domain from the candidate resource set;
report, via the physical layer, the resource set to a MAC layer; and
select, via the MAC layer, a resource from the resource set as the transmission resource.

21. The communication device according to claim 19, the one or more processors are collectively configured to:
determine, in a case where transmitting the COT sharing information via a MAC control unit, the first time window via the MAC layer according to pre-configuration information and the COT sharing information, wherein the pre-configuration information indicates a second time window used by the second UE within the COT, and the COT sharing information indicates at least one of a remaining length of the COT or a total length of the COT, wherein the remaining length of the COT indicates a length of the first time window, and the total length of the COT indicates a sum of a length of the first time window and a length of the second time window; and
determine, via the MAC layer, a later time between a start time of the resource selection window and a start time of the first time window as a start time of the overlapping time window, and an earlier time between an end time of the first time window and an end time of the resource selection window as an end time of the overlapping time window.

22. The communication device according to claim 19, the one or more processors are collectively configured to:
receive, via the MAC layer, in a case where transmitting the COT sharing information via sidelink control information (SCI), a start time and an end time reported by the physical layer, wherein the start time is a later time between a start time of the resource selection window and a start time of the first time window, and the end time is an earlier time between an end time of the first time window and an end time of the resource selection window; and
determine, via the MAC layer, the start time reported by the physical layer as a start time of the overlapping time window, and the end time reported by the physical layer as an end time of the overlapping time window.

23. The communication device according to claim 20, the one or more processors are collectively configured to:
determine the first time window via the physical layer according to pre-configuration information and the COT sharing information, wherein the pre-configuration information indicates a second time window used by the second UE within the COT, and the COT sharing information indicates at least one of a remaining length of the COT or a total length of the COT, wherein the remaining length of the COT indicates a length of the first time window, and the total length of the COT indicates a sum of a length of the first time window and a length of the second time window; and
determine, via the physical layer, a later time between a start time of the resource selection window and a start time of the first time window as a start time of the overlapping time window, and an earlier time between an end time of the first time window and an end time of the resource selection window as an end time of the overlapping time window.

24. The communication system according to claim 16, wherein the first UE is configured to:
determine whether an overlapping time window between a resource selection window and the first time window exists; and
select the transmission resource from the overlapping time window in a case where the overlapping time window between the resource selection window and the first time window exists.

25. The communication system according to claim 24, wherein the first UE is configured to:
determine the overlapping time window via a medium access control (MAC) layer; and
select, via the MAC layer, a resource within the overlapping time window in a time domain from a candidate resource set reported by a physical layer as the transmission resource, wherein the candidate resource set is determined by the physical layer through resource sensing.

26. The communication system according to claim 24, wherein the first UE is configured to:
determine, via a physical layer, a candidate resource set within the resource selection window in a time domain through resource sensing;
determine the overlapping time window via the physical layer;
determine, via the physical layer, a resource set within the overlapping time window in the time domain from the candidate resource set;
report, via the physical layer, the resource set to a MAC layer; and
select, via the MAC layer, a resource from the resource set as the transmission resource.

27. The communication system according to claim 25, wherein the first UE is configured to:
determine, in a case where transmitting the COT sharing information via a MAC control unit, the first time window via the MAC layer according to pre-configuration information and the COT sharing information, wherein the pre-configuration information indicates a second time window used by the second UE within the COT, and the COT sharing information indicates at least one of a remaining length of the COT or a total length of the COT, wherein the remaining length of the COT indicates a length of the first time window, and the total length of the COT indicates a sum of a length of the first time window and a length of the second time window; and
determine, via the MAC layer, a later time between a start time of the resource selection window and a start time of the first time window as a start time of the overlapping time window, and an earlier time between an end time of the first time window and an end time of the resource selection window as an end time of the overlapping time window.
